(19) United States
(12) Patent Application Publication
(10) Pub. No.: US 2006/0085273 A1
(43) Pub. Date: Apr. 20, 2006

(54) Method and system for transmitting notifications to users of a logistic system

(75) Inventors: Boris Mayer, Bonn (DE); Johannes Santel, Bonn (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Deutsche Post AG, Bonn (DE)

(21) Appl. No.: 10/524,063

(22) PCT Filed: Aug. 6, 2003
(86) PCT No.: PCT/DE03/02647

§ 371 Date: Feb. 9, 2005

(30) Foreign Application Priority Data
Aug. 16, 2002 (DE) 102 38 340.5

(51) Int. Cl. G06Q 99/00; G06Q 30/00

(52) U.S. Cl. 705/26; 705/1

(57) ABSTRACT

A method and system for transmitting notifications to users of a logistic system. Different events within the logistic system are used to call up different modules having respectively associated functions. The modules produce notification orders which are transmitted to a central sending component, which produces notifications which correspond to orders and sends said notifications to the users.

The invention relates to a method for transmitting notifications to users of a logistic system, in which the logistic system comprises one or more parcel compartment systems with one or more registered users, and in which the notification orders are transmitted to a central sending component which, on the basis of the orders, generates appropriate notifications and sends them to the users whereby, in order to generate the notifications, the sending component accesses one or more databases.

The invention also relates to a system for transmitting notifications to users of a logistic system that operates one or more parcel compartment systems.

In order to operate a logistic system with a plurality of users and one or more logistics providers, certain information has to be transmitted to the subscribers of the system. The transmission of information is hereinafter referred to as notification. Such notifications can take place via one or more different types of communication.

Notifications are sent on the basis of events that have occurred within the logistic system. In this context, an event in the logistic system can trigger no notification or else one or more notifications. The allocation of events of the logistic system to notifications can be carried out within a notification component as a function of a business logic.

Notifications can be transmitted via different types of communication. Here, the type of communication is the manner in which a notification is delivered. As a matter of principle, a notification with the same information content can be delivered via several types of communication.

A logistic system with different notifications and types of communication is needed, especially when a parcel compartment system for registered users is operated by a transport and delivery company. Such parcel compartment systems or automatic parcel delivery machines are operated, for example, by a postal service provider for registered users for whom a deliverer deposits parcels or other shipments into a compartment of the system. The user then has to be notified that a parcel has been deposited for him. Moreover, the logistic system has to be informed, for example, as to whether a user has picked up his parcel. Furthermore, information on the registration of new clients, client data, pick-up deadlines and COD charges has to be exchanged within the logistic system.

Within a logistic system for parcel compartment systems, notifications are typically sent by e-mail or SMS. The generation, administration and sending of the notifications preferably involves various databases and process sequences.

The use of logistic systems is known for the distribution of goods. The goods to be distributed can be all kinds of products, materials and objects. Logistic systems serve to organize and monitor the distribution of the goods in question, for example, between warehouses, intermediate storage facilities, containers, vehicles, senders and recipients via different routes of transportation. The functions of logistic systems are advantageously adapted to the requirements in such a way that the distribution of the goods can be optimized, for example, in terms of routes of transportation, capacity utilization, storage times and data transmission.

The applicant makes use especially of logistic systems for distributing letters and goods (parcels, packages), transportation boxes, pallets and containers. The appertaining logistic systems preferably serve to distribute shipments between a sender and a recipient, whereby, for example, criteria such as transportation speed, utilization of warehouses and vehicles and the transmission of shipment data are of importance.

German Utility Model 201 03 564 U1, for example, discloses a system for delivering and receiving shipments which seems to be particularly suitable for e-commerce. The system comprises several automatic delivery machines (ADM) in which shipments are deposited and picked up. The system also comprises a LAMIS server-computer program for handling the operations of the system. The client is informed, for example, via types of communication such as e-mail, about shipments deposited for him at the ADM.

Furthermore, U.S. Pat. No. 6,047,264 discloses a method for transmitting the status of a shipment of a user in which an entry in a central database is generated when a user orders a shipment. If the status of the shipment changes, for example, when it is transferred to a delivery company, when it is transported to various stations or when it arrives at the destination, then the status change is collected in the database. This collection can be carried out manually or electronically. Via a query module, a notification component continually requests status changes from the database and generates messages to the user of a shipment for which the status has changed. The notification is preferably made by e-mail.

International patent application WO 02/50705 A1 describes a distribution system for electronic documents such as e-mails. These e-mails contain, for example, attachments for advertising purposes. The system aims to prevent the drawbacks of existing e-mail systems such as, for instance, the fact that a sender cannot receive information as to whether a recipient has opened the attachment to an e-mail, or whether the sender does not have software that would be needed to open a file. Moreover, it sends statistical information to the sender when a recipient has opened an electronic document. The system consists essentially of a generating module that generates a master document from a template and from selectable information of a sender. The master document is checked and transferred to a sending module that sends the document to one or more recipients.

U.S. Pat. No. 6,220,509 B1 discloses a parcel trace system in which status information about a shipment is recorded directly in the client database. In this case, the client database is preferably accessed via an Internet web page.

European patent application EP 0 491 367 A2 discloses a method for processing messages in which orders are stored in a queue in order to be executed in a controlled manner. Here, the orders can be adapted to different conditions and features of the destinations and to communication connections. The method is especially well-suited for use in e-mail systems.

The objective of the invention is to provide a method and a device for transmitting notifications to users of a logistic system which allows the most flexible response possible to different events within the system and the generation of user-specific notifications. In this context, the logistic system should encompass the operation of at least one electronic parcel compartment system.

According to the invention, this objective is achieved by the subject matter of the independent Claims 1 and 5. Advantageous embodiments of the invention ensue from the subordinate claims 2 to 4.

According to the invention, this objective is achieved in that, in response to different events within the logistic system, different modules with associated functions are called up in each case, whereby the modules generate notification orders that are transmitted to a central sending component which, on the basis of the orders, generates appropriate notifications and sends them to the users.

Additional advantages, special features and practical embodiments of the invention ensue from the subordinate claims and from the presentation below of preferred embodiments, making reference to the figures.

The figures show the following:

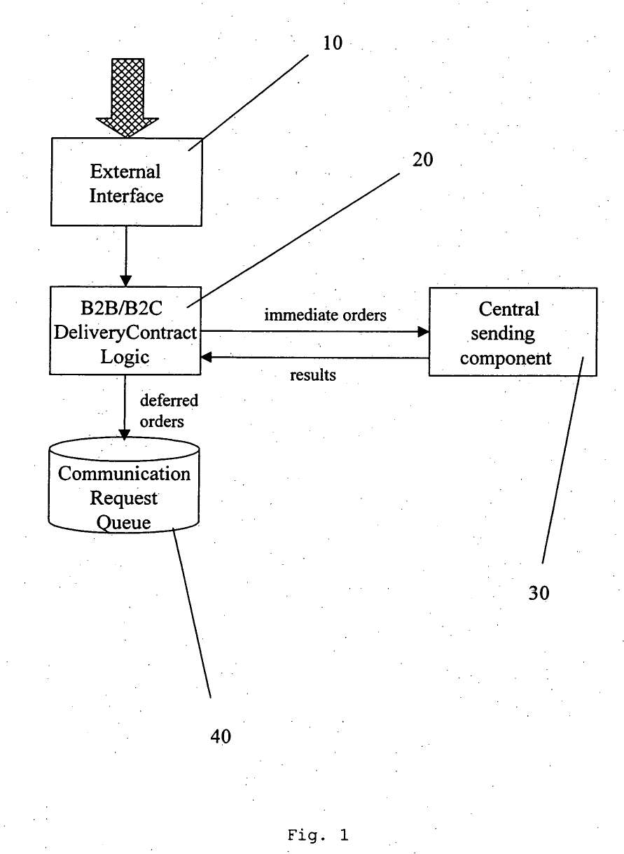

FIG. 1 the process sequences between an external interface, a central sending component and a communication request queue of an especially preferred embodiment;

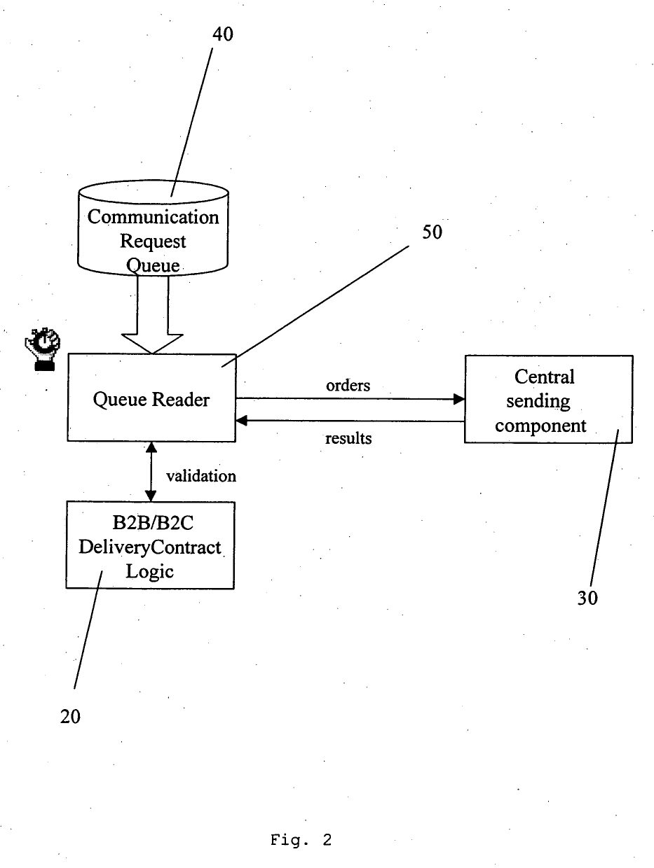

FIG. 2 the process sequences between a communication request queue, a central sending component and a delivery contract logic of an especially preferred embodiment;

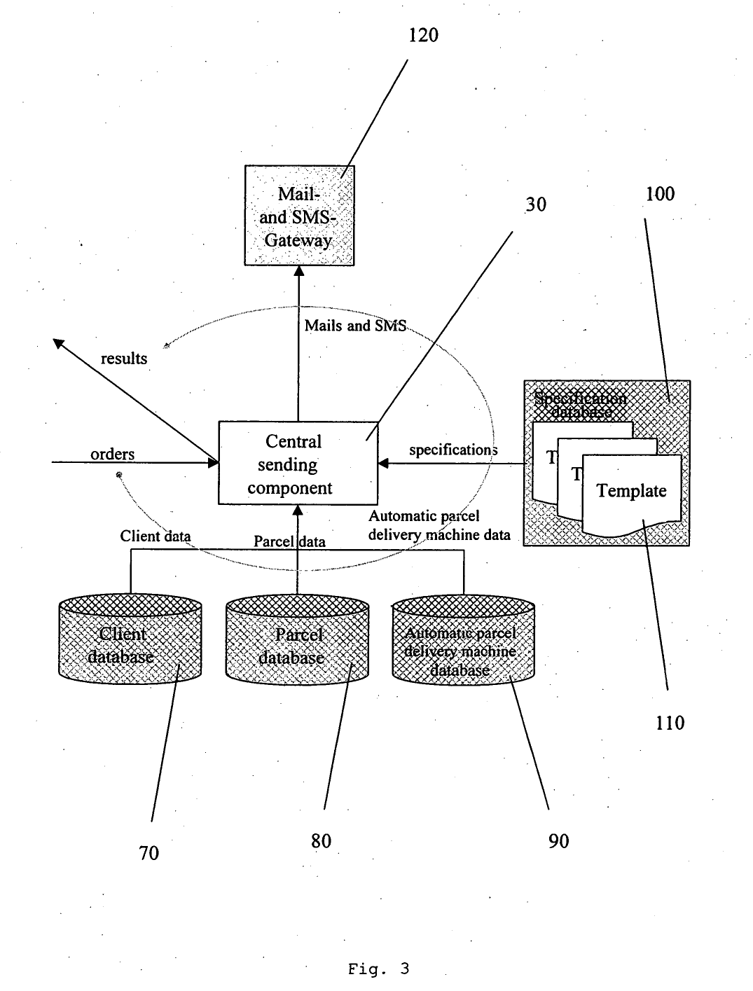

FIG. 3 the process sequences between a central sending component, various databases and a gateway; and

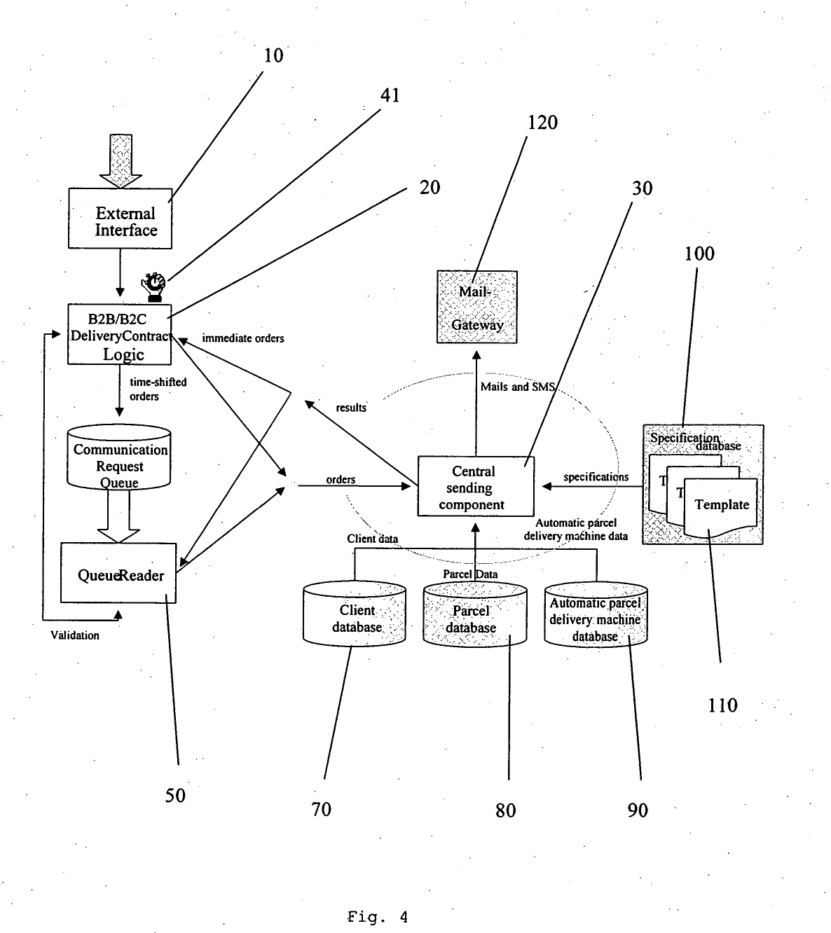

FIG. 4 a general overview of the sequences within the system for transmitting notifications.

Below, a logistic system is described for operating a system comprising one or more parcel compartment systems with a variable number of registered users. This is an especially preferred embodiment of the invention, but the method according to the invention is also suitable for other logistic systems in which notifications are sent.

The logistic system for operating one or more parcel compartment systems is divided, for example, into at least the following processing steps on the basis of the functions:
UC BNK1 confirmation of the registration of a client
UC BNK2 change in the client data
UC BNK3 notification ‘new parcel’
UC BNK5 notification ‘parcel was picked up’
UC BNK6 notification ‘parcel was sent back’
UC BNK7 notification ‘substitute added’
UC BNK8 notification ‘substitute removed’

Notifications are sent to the user for the above-mentioned events within the system and these notifications inform the user of the event and/or confirm it. In an especially preferred embodiment of the invention, the execution of the individual processing steps is carried out by various modules and/or units of the logistic system. These modules can be, for example, a client database, a registration unit or a system administration unit for the logistic system. The modules, optionally together with other components, form an external interface 10.

The sequence and the function procedure call within the modules are explained below. The notification orders generated by the modules are either transferred to a central sending component 30 so that they can be sent immediately or else they are read into a communication request queue 40 so that they can be sent in a deferred manner. All of the waiting notification orders are regularly read from this queue and appropriate notifications are sent. Generated notifications are preferably sent by e-mail or SMS.

UC BNK1 Confirmation of the Registration

After the registration of a new client for the logistic system of the parcel compartment systems, a registration module calls up a function
newRecipient (User)
   in order to send a confirmation notification. The function determines the necessary notifications on the basis of the clientele logic of the clientele associated with the client and said function enters this into a communication request queue so that they can be sent in a deferred manner.
   UC BNK2 Change in the Client Data

After a client has changed his client data that is stored in a client database, the client database calls up a function
updateRecipient (User)
   in order to send a confirmation notification. This function likewise determines the necessary notifications on the basis of the clientele logic of the clientele associated with the client and said function enters this into the communication request queue so that they can be sent in a deferred manner.
   UC BNK3 Notification ‘New Parcel’

When a parcel is delivered to an automatic parcel delivery machine of a logistic system, information to this effect is sent to a system administration unit for the logistic system. The system administration unit for the logistic system calls up a function
notifyDelivery (Parcel)
   in order to send a confirmation notification. This function determines the necessary notifications on the basis of the clientele logic of the clientele associated with the parcel and said function enters this into the communication request queue so that they can be sent in a deferred manner.
   UC BNK5 Notification ‘Parcel was Picked Up’

When a parcel has been picked up from an automatic parcel delivery machine of a logistic system, information to this effect is sent to the system administration unit for the logistic system. The system administration unit for the logistic system then calls up a function
notifyPickup (Parcel)
   in order to send a confirmation notification. The function determines the necessary notifications on the basis of the clientele logic of the clientele associated with the parcel and said function enters this into the communication request queue.
   UC BNK6 Notification ‘Parcel was Sent Back’

When a parcel has been sent back from an automatic parcel delivery machine of a logistic system because it was not picked up before a certain pick-up deadline, information to this effect is sent to the system administration unit for the logistic system. The system administration unit for the logistic system calls up a function
parcelFailed (Parcel)
   in order to send a confirmation notification. The function determines the necessary notifications on the basis of the clientele logic of the clientele associated with the parcel and said function enters this into the communication request queue.
   UC BNK7 Notification ‘Substitute Added’

When a substitute has been added for a waiting parcel in an automatic parcel delivery machine of a logistic system, information to this effect is sent to the system administration unit for the logistic system. The system administration unit for the logistic system then calls up a function
addSubstitute (Parcel, User)
   in order to send a confirmation notification. The function determines the necessary notifications on the basis of the clientele logic of the clientele associated with the parcel and said function enters this into the communication request queue.
   UC BNK8 Notification ‘Substitute Removed’

When an added substitute has been removed for a waiting parcel in an automatic parcel delivery machine of a logistic system, information to this effect is sent to the system administration unit for the logistic system. The system administration unit for the logistic system calls up a function
removeSubstitute (Parcel, User)
   in order to send a confirmation notification. The function determines the necessary notifications on the basis of the clientele logic of the clientele associated with the parcel and said function enters this into the communication request queue.

In addition, for example, the following events can be mapped by functions within modules:

Automatic parcel delivery machine not functional notifyADMfailed

(Parcel parcel, Boolean failure)

Generic notification genericNotification

(Parcel parcel, Addressable add, int type)

Notification to delivery provider: parcel delivered

notifyDeliveryProvider (Parcel parcel)

Notification to delivery provider: parcel removed

notifyPickupProvider (Parcel parcel)

Branch

notifyBranch (String description, DeliveryMachine adm, Addressable recipient, Boolean branchCODparcel)

Product lock

notifyWarehouseDelivery (String description, DeliveryMachine adm, Addressable recipient)

Address check failed

notifyAdressCheckFailed (String description, Addressable recipient)

Internet password

notifyInternetPassword (String description, Addressable recipient)

Generic message text

notifyGenericMessageText (String description, Addressable recipient)

Delivery returns provider

notifyDeliveryReturnsProvider (Parcel parcel)

Pickup returns provider

notifyPickupReturnsProvider (Parcel parcel)

Pickup by delivery agent provider

notifyPickupByDeliveryAgentProvider (Parcel parcel)

E-mail changed

notifyEmailChanged (Addressable recipient)

Mobile phone number changed

notifyMobileNumberChanged (Addressable recipient)

Postal PIN changed

notifyPostPinChanged (Addressable recipient)

Password changed

notifyInternetPasswordChanged (Addressable recipient)

Notifications are preferably sent in the form of an e-mail or SMS. An e-mail or SMS gateway, for example, can be used for this purpose.

In order to use the method according to the invention in actual practice, it has proven to be advantageous for the list of undeliverable notifications to be revised manually at regular intervals (e.g. every 24 hours).

The drawings in FIGS. 1 to 4 show an overview of the most important partial components of an especially preferred embodiment of the system according to the invention. The external systems are marked with cross-hatching, whereas the parts belonging to the notification system are shown in white.

The drawing in FIG. 1 shows the structure of an especially preferred embodiment of a notification component. The notification component is connected to an external interface 10 that is called up externally when certain events of the logistic system have occurred. The interface is formed by several modules, each with associated functions. The events of the logistic system are converted into notification orders by a B2B account logic component (not shown here). For certain special cases, these orders can be sent directly via a central sending component 30. As a standard procedure, however, the orders are written into a communication request queue 40 and then transmitted to the central sending component 30 in a timer-controlled manner. This allows, for example, reminder notifications to be defined at later points in time (e.g. after 2 days or 7 days). The writing into the queue also has the advantage that failed sending attempts are automatically repeated here.

The drawing in FIG. 2 shows the process sequence after the notification orders have been written into the communication request queue 40. The orders present in the communication request queue 40 are read out by a queue reader 50 in a timer-controlled manner. A checking procedure once again checks against a B2B delivery contract logic 20 whether the status has changed in the meantime. A status change has occurred, for example, when a deposited parcel has been picked up or the person picking it up has been changed. If the validation was successful, then a communication request is transmitted to the sending component 30.

The drawing in FIG. 3 shows the process sequence in conjunction with the central sending component 60. The process flow within the sending component is indicated by arrows. The sending component receives orders externally and then reads the requisite data from the connected databases for purposes of transmitting the notification. These databases include at least one client database 70, a parcel database 80 and an automatic parcel delivery machine database 90. The automatic parcel delivery machine database contains data about the parcel compartment units of the system. Then, a template 110 specified by the B2B component 20 is read out from the document database 100 and placeholders within the template are replaced by the current data. The e-mail or SMS generated in this manner can be sent, for example, via an e-mail and SMS gateway 120.

The drawing in FIG. 4 combines the three parts of the notification component into a general overview. Here, one can clearly see the separation between the central sending component 30 on the right-hand side and the parts of the business logic component on the left-hand side.

Below, the individual components of the system and their functions within an especially preferred embodiment of the method according to the invention will be explained in greater detail.

External Interface

The external interface 10 is connected to the notification component and results in a straightforward manner from various Use Cases: for each Use Case, preferably a function of its own is defined that achieves the requisite functionality within the notification component.

These functions correspond to the events of the logistic system and relate, for example, to parcel objects and/or user objects. The functions can, of course, be expanded and can also relate to other objects.
newRecipient (User)
is called up after the registration of a new client.
updateRecipient (User)
is called up after a client has changed his client data that is stored in the client database.
notifyDelivery (Parcel)
is called up when a parcel has been delivered to an automatic parcel delivery machine of a logistic system.
notifyPickup (Parcel)
is called up when a parcel has been picked up from an automatic parcel delivery machine of a logistic system.
parcelFailed (Parcel)
is called up when a parcel has been sent back from an automatic parcel delivery machine of a logistic system because it was not picked up before a certain pick-up deadline.
addSubstitute (Parcel, User)
is called up when an added substitute has been added for a waiting parcel in an automatic parcel delivery machine of a logistic system.
removeSubstitute (Parcel, User)
is called up when a substitute has been removed for a waiting parcel in an automatic parcel delivery machine of a logistic system.

The parcel or user objects in question each receive methods. Internally, the event of the logistic system is converted into notifications that are temporarily stored in the internal queue 40. The result provided by the methods gives feedback as to whether this conversion and temporary storage functioned or not.

Template Mechanism

Requisite Templates

Various types of notifications can be sent for which it has proven to be advantageous to create templates 110 and to store these in a document database. The types of notifications are mapped by means of a template name that classifies the templates on the level of the information content of the notification. For the B2B case, for example, the following templates are needed:

| | |
|---|---|
| New client registration | BNK1 |
| Change in client data | BNK2 |
| Parcel delivery | BNK3, BNK3N |

Parcel has been Waiting for 48 Hours BNK4, BNK4N

| | |
|---|---|
| Parcel will be sent back | BNK5, BNK5N |
| in 48 hours | |

Template variants for parcels with COD and parcels without COD can be used for the last three types of parcel notifications. In addition to the name, the templates are also identified via the DeliveryContract, the type of communication and the language. In addition to the described templates, of course, any number of other templates can be used.

Templates should be available for all notifications to be sent in the form of SMS as well as e-mail. For sending by e-mail, templates should preferably be available for the message text as well as for the reference line.

Database Storage

In order to simplify the management of the templates 110, they are stored in a database 100. In an especially preferred embodiment of the invention, this database comprises several fields that are depicted in table form below:

| Field | Description | Type | Example |
|---|---|---|---|
| Contract | ID of the | VARCHAR (16) | LC_4711, |
| | DeliveryContract, | | LP_4712, |
| | of the | | DC_4713 |
| | LogisticPartner or | | |
| | LogisticProvider | | |
| CommType | Type of | VARCHAR (12) | SMS, PlainText, |
| | communication | | MailHeader, |
| | | | later optionally |
| | | | HTMLmail, |
| | | | pager, fax |
| Notification | Type of | VARCHAR (12) | BNK1, BNK2, |
| | notification, see | | BNK3, BNK3N, |
| | Section 0 | | BNK4, BNK4N, |
| | | | BNK5, BNK5N |
| Lang | Language | VARCHAR (5) | de-Germany |
| | | | en-U.S.A. |
| Template text | Stored | VARCHAR | |
| | template text | (2048) | |

It should be noted that, as a function of the event of the logistic system for notification, the database key ‘Contract’ can be a LogisticProvider or a LogisticContractor (in the case of BNK1 and BNK2) or else a DeliveryContract (in the case of BNK3 to BNK5).

Placeholder Mechanism

It has proven to be advantageous to use various placeholders within the templates 110 which can be replaced with concrete information. With an eye towards the use of HTML-formatted e-mails, these placeholders should advantageously not be defined as HTML tags.

At least the following placeholders can be provided:

| | |
|---|---|
| >M_NR< | event of the logistic system client number |
| >M_Address< | form of address |
| >M_FirstName< | first name |
| >M_SurName< | surname |
| >M_SMS< | SMS number of the client |
| >M_Mail< | e-mail address of the client |
| >M_Street< | street and house number of the client |
| >M_ZipCode< | ZIP code of the client |
| >M_City< | city name of the client |
| >AUT_Street< | street and house number of the automatic parcel |
| | delivery machine |
| >AUT_ZipCode< | ZIP code of the automatic parcel delivery machine |
| >AUT_City< | city name of the automatic parcel delivery machine |
| >POD_Amount< | COD amount and currency |

In addition to the described placeholders, of course, other placeholders can be used as well.

Message Length

The maximum length for SMS messages is typically 160 characters. Since certain information—such as the location of the event of the automatic parcel delivery machine of a logistic system—can have variable lengths, excessively long fields (e.g. streets or cities with city district information) can cause an ‘overflow’ of the 160 characters. In order to avoid such an ‘overflow’, in an especially preferred embodiment of the invention, an intelligent mechanism is employed which, depending the individual field lengths, on the importance of each field and on the available remaining length, contains all of the essential information to the extent possible.

An alternative to an intelligent mechanism is the storage of short versions of all of the fields in the appropriate databases so that the maximum length of 160 characters is never exceeded. However, this has the drawback that changing SMS templates entail new length limitations. Thus, certain information such as the address entered by the client cannot be easily adapted.

B2B DeliveryContract Logic

The B2B DeliveryContract logic 20 determines what the individual business logic should look like for a certain LogisticProvider, a certain LogisticContractor, and a certain DeliveryContract (between a certain logistic provider and a certain logistic contractor). For this purpose, the individual events are converted into notification orders. The events of the logistic system newRecipient and updateRecipient depend only on the LogisticProvider or LogisticContractor with which the corresponding user is associated. The other events of the logistic system relate to the delivery of parcels, that is to say, they depend on the LogisticProvider (who transports the parcel) as well as on the LogisticContractor (who defines the recipient or deliverer of the parcel). In order to implement the logic, a list of notifications to be sent (communication requests) is defined for each event of the logistic system. These communication requests comprise several parameters that can be set.

Events of the Logistic System

Multiple notifications can be stored for each event, for example, if repeated notifications are made, or if several persons with different roles are to be informed.

Persons to be informed are those persons which are to be notified. Possible values are: Recipient, Substitute, LogisticProvider or LogisticContractor.

A date is specified on which the notification is to be sent. In the logic, only a relative date is stored and this is then computed with the date of the event of the logistic system in order to generate an absolute date. Possible values here are, for example:

Immediately the notification is sent immediately

+X time units the notification is sent in X time units

−X time units the notification is sent X time units before the expiry of the parcel

A certain type of communication can be specified. This is needed, for instance, if a certain logic only allows notifications by SMS. Possible values are e-mail, SMS and User (the type of communication specified for the user). In this manner, for example, a delivery contract logic can be mapped that exclusively allows notifications via a specific type of communication.

Preferably, the possibility exists to select a template 110 that is to be used for the transmission. This has the advantage that different texts can be rendered useable within the same delivery contract, for example, for different events of the logistic system. In addition, the template is always further limited by the current DeliveryContract. Thus, a certain template (e.g. BNK1) can also have different contents for two different DeliveryContracts. Moreover, different versions of the same templates can be kept available for the different types of communication.

Furthermore, additional information can be stored that is used for differentiating within the business logic or that is used for checking the logic later on, such as the two possible pieces of information described below:

Differentiation in the Case of COD Parcels

Here, a different template is used for parcels with a set COD amount. This template contains, for example, the COD amount as information for the person picking up the parcel.

There are B2B processes in which a COD amount is present for the parcel, but this amount is not transmitted to the person picking up the parcel since the COD is invoiced, for example, via combined billing.

Checking Whether a Parcel was Picked Up

This is a checking operation is carried out to see whether a parcel is still in the automatic parcel delivery machine of the logistic system or whether it has been picked up in the meantime. This is particularly helpful if reminder notifications are sent, for example, after a few days.

The parcel object has to provide a method that provides feedback on the expiry date on which the parcel will be removed from the automatic parcel delivery machine. This is needed in order to be able to transmit notifications X days before the expiry. If no expiry date has been set, then as a standard procedure, a certain number of calendar days can be assumed.

LogisticProvider DPAG (B2C Case)

The following table is an example defining the notifications to be sent (communication requests) at the time of the registration of users for a LogisticProvider. These are the deliverers, no notifications are sent.

| | | | | | |
|---|---|---|---|---|---|
| | Person to be | Date: | | | |
| Event of | informed | immediately, | Type of | | |
| the | (Recipient, | +X days, | communication | | |
| logistic | Substitute, | −X days | (e-mail, SMS, | Tem- | |
| system | LP, LC | (before expiry) | user) | plate | Other |

| | | | | |
|---|---|---|---|---|
| New user | — | — | — | — |
| User | — | — | — | — |
| changed | | | | |

LogisticContractor Final Client (B2C Case)

The following table is an example defining the notifications to be sent (communication requests) at the time of the registration of users for a virtual LogisticContractor ‘final client’. This is where all of the users who are registered for the B2C case are compiled.

| | Person to be | Date: | | | |
|---|---|---|---|---|---|
| Event of | informed | immediately, | Type of | | |
| the | (Recipient, | +X days, | communication | | |
| logistic | Substitute, | −X days | (e-mail, SMS, | | |
| system | LP, LC | (before expiry) | user) | Template | Other |
| New user | Recipient | Immediately | User | BNK1 | No SMS at |
| | | | | | night |
| User changed | Recipient | Immediately | User | BNK2 | No SMS at |
| | | | | | night |

Delivery Contract Logic→Final Client (B2C Case)

The following table is an example defining the notifications to be sent (communication requests) for the B2C logic between a logistic provider and the final client:

| | Person to be | Date: | | | |
|---|---|---|---|---|---|
| Event of | informed | immediately, | Type of | | |
| the | (Recipient, | +X days, | communication | | |
| logistic | Substitute, | −X days | (e-mail, SMS, | | |
| system | LP, LC | (before expiry) | user) | Template | Other |
| Parcel | Recipient | Immediately | User | BNK3, | Differentiation |
| delivered | | | | BNK3N | in the case of |
| | | | | | COD parcels |
| | | | | | Checking |
| | | | | | whether parcel |
| | | | | | was picked up |
| | | | | | No SMS at night |
| | Recipient | +2 days | User | BNK4, | Differentiation |
| | | | | BNK4N | in the case of |
| | | | | | COD parcels |
| | | | | | Checking |
| | | | | | whether parcel |
| | | | | | was picked up |
| | | | | | No SMS at night |
| | Recipient | −2 days | User | BNK5, | Differentiation |
| | | | | BNK5N | in the case of |
| | | | | | COD parcels |
| | | | | | Checking |
| | | | | | whether parcel |
| | | | | | was picked up |
| | | | | | No SMS at night |
| Parcel | — | — | — | — | |
| picked up | | | | | |
| Parcel | — | — | — | — | |
| sent back | | | | | |
| Substitute | — | — | — | — | |
| added | | | | | |
| Substitute | — | — | — | — | |
| removed | | | | | |

LogisticProvider LP (B2B Case)

| | | | | | |
|---|---|---|---|---|---|
| | Person to be | Date: | | | |
| Event of | informed | immediately, | Type of | | |
| the | (Recipient, | +X days, | communication | | |
| logistic | Substitute, | −X days | (e-mail, SMS, | Tem- | |
| system | LP, LC | (before expiry) | user) | plate | Other |

| | | | | |
|---|---|---|---|---|
| New user | — | — | — | — |
| User | — | — | — | — |
| changed | | | | |

LogisticContractor LC (B2B Case)

| | Person to be | Date: | | | |
|---|---|---|---|---|---|
| Event of | informed | immediately, | Type of | | |
| the | (Recipient, | +X days, | communication | | |
| logistic | Substitute, | −X days | (e-mail, SMS, | | |
| system | LP, LC | (before expiry) | user) | Template | Other |
| New user | Recipient | Immediately | User | BNK1 | SMS also at |
| | | | | | night |
| | Expediter | Immediately | User | ??? | SMS also at |
| | | | | | night |
| User changed | Recipient | Immediately | User | BNK2 | SMS also at |
| | | | | | night |
| | Expediter | Immediately | User | ??? | SMS also at |
| | | | | | night |

DeliveryContract Logic LP→LC (B2B Case)

| | Person to be | Date: | | | |
|---|---|---|---|---|---|
| Event of | informed | immediately, | Type of | | |
| the | (Recipient, | +X days, | communication | | |
| logistic | Substitute, | −X days | (e-mail, SMS, | | |
| system | LP, LC | (before expiry) | user) | Template | Other |
| Parcel | Recipient | Immediately | User | BNK3 | Checking |
| delivered | | | | | whether parcel |
| | | | | | was picked up |
| | | | | | SMS also at |
| | | | | | night |
| | Expediter of | +4 days | User | ??? | Checking |
| | the recipient | | | | whether parcel |
| | | | | | was picked up |
| | | | | | SMS also at |
| | | | | | night |
| Parcel | — | — | — | — | |
| picked up | | | | | |
| Parcel | — | — | — | — | |
| sent back | | | | | |
| Substitute | Substitute | Immediately | User | BNK3 | Checking |
| added | | | | | whether parcel |
| | | | | | was picked up |
| | | | | | SMS also at |
| | | | | | night |
| Substitute | — | — | — | — | |
| removed | | | | | |

CommunicationRequest Queue

A dedicated database table is needed in which orders for notifications (communication requests) to be sent are temporarily stored. The table should preferably only serve to manage the queue; concrete information on parcels and recipients, for example, is always read from the client database 70 or from the parcel database 80.

| | | | |
|---|---|---|---|
| Field | Description | Type | Example |

Internal fields that are needed in order to execute the sending

| | | | |
|---|---|---|---|
| RequestID | Unambiguous key for identifying | NUMBER (16) | |
| | the entries, is continuously generated | PRIMARY | |
| | internally | KEY | |
| InsertDate | Date of insertion into the queue, is | DATE | |
| | generated internally | | |
| Completion | Date of the complete processing | DATE | |
| Date | (status = 2) or failure (status = 9) | | |
| RetryCount | Number of previous failed | NUMBER (3) | |
| | attempts | | |
| State | Status of the request | NUMBER (3) | 1 = new |
| | | | 2 = processed |
| | | | (complete) |
| | | | 3 = being processed |
| | | | (locked) |
| | | | 9 = failed |

Fields prescribed externally, these are supplied by the B2B component

| | | | |
|---|---|---|---|
| SendDate | Date and time of day, after which | DATE | |
| | it should be sent. | | |
| RecipientID | ID of the recipient, this can be a | VARCHAR (16) | LP_4711, LC_1234, |
| | user, a logistic provider or a | | US_0815 |
| | logistic contractor | | |
| ParcelID | Parcel number (can be blank) | VARCHAR (16) | |
| Communication | Parameters for controlling the | NUMBER (8) | CheckParcel |
| flags | sending, are set by the B2B | | InMachine |
| | component so that the decisions | | DelaySMS Sending |
| | made in the clientele logic can be | | |
| | reconstructed in case of later | | |
| | questions | | |

Fields prescribed externally, which identify the template to be used

| | | | |
|---|---|---|---|
| Contract | ID of the DeliveryContract, of the | VARCHAR (16) | LP_4711, LP_4712, |
| | LogisticPartner or of the Logistic- | | LP_4713 |
| | Provider | | |
| CommType | Type of communication | VARCHAR (12) | SMS, PlainText, User |
| | | | (= take the settings of |
| | | | the user, later |
| | | | optionally TMLMail, |
| | | | RFC1149, Pager, |
| | | | FAX |
| Notification | Name of the template to be used, | VARCHAR (12) | BNK1, BNK2, BNK3, |
| | see Section 0 | | etc. |
| Lang | Language | VARCHAR (5) | de-Germany |
| | | | en-U.S.A., user |

However, it can be advantageous to expand the fields of the communication request queue. For example, automatic parcel delivery machine numbers and free text descriptions can be added. In this manner, notifications are not only coupled to parcels but optionally also to a combination of postal numbers, events and automatic parcel delivery machine numbers. Moreover, the possibility exists to generate notifications dynamically.

With the Comm_Type entry, via a value User, it can be specified that the notification is to be made via the type of communication specified by the user. Analogously, the value User can be entered for the language setting Lang if the settings of the user are to be used. Whether and the extent to which a logging of an entry (status=3) is necessary depends on the concrete implementation.

Access to Databases

Access to'the following databases of the logistic system has to be provided:
Client database supplies information about a client who is identified by the client number.
LogisticProvider database supplies' information about a logistic provider.
LogisticContractor database supplies information about a logistic contractor.
DeliveryContract database supplies information about a logistic contractor.
Parcel database supplies information about a parcel that is identified by an unambiguous parcel number.
Automatic parcel delivery machine database supplies information about the location of an automatic parcel delivery machine that is identified by the automatic parcel delivery machine ID.
   Sequence of the Sending of a Notification
   Timer

The notification component regularly checks all of the orders in the communication queue 40. This is triggered by a timer 41 within the notification component. The timer interval can preferably be configured freely.

Communication Queue Reader

When the timer function is called up, all of the entries whose sending date is after the current date are read from the communication request queue 40.

| Select * from communication_request_queue | | |
|---|---|---|
| where | state = 1 | // not yet processed |
| and | SendDate < now( ) ; | // and now current. |

Reconstruction of the Objects

Each entry that is read from the queue is converted into a CommunicationRequest object. On the basis of the unambiguous ID for the user to be informed (RecipientID) and of the ID for the parcel (ParcelID), the partial objects in question are reconstructed. This is necessary in order to be able to query the current data of the objects such as, for example, the e-mail address.

The term User in this case refers either to a User, a LogisticProvider object or a LogisticContractor object. All of these objects implement a shared interface Notifiable. This provides the methods needed for sending a notification to the appertaining object. The Parcel object can optionally be dispensed with if, for example, a notification is to be sent independent of a parcel delivery, for example, in case of a client registration.

The Parcel object, in turn, provides a method by means of which the automatic parcel delivery machine in which the parcel is located can be accessed.

The read-out data of the objects comprises data to be transmitted (such as name, address, location of the automatic parcel delivery machine) as well as control data (such as e-mail and/or SMS, e-mail address).

Logic Checking

The communication requests that are read from the queue 40 are checked against the B2B DeliveryContract logic 20 to see whether they are still valid notifications. If only one single checking procedure is carried out, there is a need to check against the data from the parcel database 80 to make sure that the parcel has not yet been picked up. If the parcel was picked up in the meantime, the notification is considered to have been completed. For this purpose, the status of the communication request is removed from the internal queue of the orders that are still to be processed (the status is set at 2=completely processed).

If the parcel in the parcel database 80 no longer exists, it is assumed that it was picked up in the meantime, and the communication request is likewise removed from the internal list of orders that still have to be processed.

Central Sending Component

The notifications are transferred to the central sending component 30. There, based on type of communication indicated in the communication request and on the settings of the user, it is ascertained which type of communication is to be used to deliver the notification. Here, an error might occur if a certain type of communication is specified but the user does not support this type of communication.

If only one type of communication is desired, then the desired SPI (Service Provider Interfaces) are called up directly. If the user desires a notification via several types of communication, measures have to be taken in case the notification is successful via the first type of communication but not via the second. Then, this second type of communication has to be attempted repeatedly without once again using the first type of communication. For this purpose, it is best to issue a duplicate of the CommunicationRequest object for each desired type of communication and to then transfer it to the appropriate SPI.

Sending Via Individual Types of Communication

The individual types of communication are mapped via so-called SPI's (Service Provider Interfaces). There is such an SPI for each type of communication. Each SPI is called up with the communication request object. As a function of the data in this object, an e-mail and/or SMS is created. For this purpose, the appropriate template 110 is read in, and the placeholders are replaced by the information read from the appropriate database.

Delaying the Sending

A possible desired restriction pertaining to the sending of notifications is that processing at night (e.g. 10:00 p.m. to 6:00 a.m.) is suppressed either entirely or only for SMS notifications. If a complete discontinuation of the sending is desired, this can be achieved, for instance, by means of the timer. However, since e-mails do not cause a disturbance, it is preferable to suppress only the sending of SMS notifications at night. For this purpose, the sending is interrupted within the SMS SPI's and the sending date is set at the next appropriate time within the permissible window of time. At the first occasion when the timer reaches this window of time, the communication request is read again and executed.

Plausibility Checks

The notification component carries out a plausibility check of the data to be transmitted. The client has to exist in the client database 70 and the parcel has to exist in the parcel database 80. If, for example, a client has already been deleted, a notification is no longer sent. Moreover, information about the automatic parcel delivery machine (location) has to be present. It is checked whether the recipient address (e-mail or mobile phone number) is potentially correct and whether all of the placeholders of the template 110 can be filled with data. Moreover, the existing templates must have certain plausibilities: as a function of the template type (this, in turn, varies in terms of the language, the type of communication and the B2B logic), the following important data fields have to be present in the templates:

| Template | Remark | Required placeholder in the template |
|---|---|---|
| BNK1 | New client | None |
| BNK2 | Client data | None |
| | changed | |
| BNK3, BNK4, | Parcel | >AUT_Street<, >AUT_ZipCode<, |
| BNK5 | waiting | >AUT_City< |
| BNK3N, BNK4N, | COD parcel | >AUT_Street<, >AUT_ZipCode<, |
| BNK5N | waiting | >AUT_City<, >POD_Amount< |

If a template is not present or if it does not have any appropriate entries, the sending is discontinued and an appropriate error message is generated in a LOG file. The templates should be checked. If the sending is carried out by SMS, an intelligent mechanism can adapt the messages to a maximum length of 160 characters.

Carrying out the Sending

The mechanism described in the section TemplateMechanism generates the text to be sent. The text and the recipient information are transmitted to an e-mail or SMS gateway 120 as a function of the type of sending. If the transmission to the gateway fails, then a second transmission can be attempted right away in order to more easily be able to overcome brief malfunctions.

Storing the Result

If the entire procedure was successful, then, in an especially preferred embodiment of the invention, the entry is deleted from the queue of outstanding orders in that the field state is set at ‘2’. At the same time, the field CompletionDate is set at the current date+time of day. Such entries in the communication queue 40 are not further processed. They should advantageously remain available in the communication queue for a certain period of time for the eventuality that a notification might be undeliverable.

An error can occur for a number of reasons:
The client is not in the client database 70 or the automatic parcel delivery machine is not in the automatic parcel delivery machine database 90.
The read-in data is not plausible (for example, not filled in completely).
The templates are erroneous or not present.
Sending the notification is not possible for technical reasons (after several attempts).

If an error occurs, the field ‘RetryCount’ is increased. If the RetryCount exceeds a predefined value (this is also dependent on the frequency of the timer), an error message is generated in a LOG file and, for example, a manual re-processing is initiated. This can be, for instance, a check of the stored data or a manual removal of entries from the communication queue. In order to prevent these erroneous notifications from being attempted time and again, the status is set at ‘9’ as soon as a certain RetryCount has been reached. These notifications are not processed. Moreover, the current date is stored as the date of the interruption in the field CompletionDate. After elimination of the error, the status has to be manually set at ‘1’ again. The CompletionDate and the RetryCount likewise have to be reset.

Regular Clean-Up

Regular ‘clean-up’ of the communication request queue is necessary. All of the completed cases that have been finished for longer than a certain period of time (for example, one week) should be removed from the database. Moreover, all of the error cases that are older than one month should be removed from the communication request queue. The date of the completion or interruption is stored in the field CompletionDate. For example, the following is executed:

Delete from communication_queue

| | | |
|---|---|---|
| where | state = 2 | and completion_date < now + 7 days |
| or | state = 9 | and completion_date < now + 30 days. |

Logging Mechanism

Errors in sending e-mails or SMS should also be logged in an error LOG file. These LOG files have to be monitored regularly, for example, so as to be able to ascertain the failure of a gateway. Furthermore, at least in the first phase, all sent notifications should likewise be logged. For this purpose, a dedicated LOG file is used in order to simplify the error monitoring.

Design Proposals and Restrictions

There are several alternatives for the implementation of the timer. It can be realized
via the internal timer of the application server,
via a cron job,
via a database timer or
via a differently developed solution.

Preference is given to the first variant. There are also several possible alternatives for carrying out the e-mail and SMS sending procedures:
JMAPI (Java Message API)
JMS
utilization of a suitable e-mail service of the application server.

Here, the first two variants are preferred.

Layout

The notification component does not have to comprise any surfaces or Internet pages. However, different templates are necessary for the individual notifications. It is advantageous here for the templates to be readily exchangeable. The templates depicted in the following sections are merely embodiments by way of example. Of course, any desired notification texts can be integrated with the appropriate placeholders.

BNK1=Confirmation of the Registration

Notification by E-Mail

```
Welcome to the packing station
Hello >M_Address< >M_SurName<.
You have registered at the packing station with the following data:
      >M_Address< >M_FirstName< >M_SurName<
      >M_Street<
      >M_ZipCode< >M_City<
      e-mail: >M_Mail<
      SMS: >M_SMS<
Your membership number is >M_NR<
```

Notification by SMS
Welcome to the packing station. Your membership number is>M_NR<
BNK2=Confirmation of Change in the Client Data

Notification by E-Mail

```
Change of your address data at the packing station
Hello >M_Address< >M_SurName<.
You have changed the data you have stored at the packing station to the
following:
      >M_Address< >M_FirstName< >M_SurName<
      >M_Street<
      >M_ZipCode< >M_City<
      e-mail: >M_Mail<
      SMS: >M_SMS<
Your membership number is >M_NR<
```

Notification by SMS

Hello >M_Address< >M_SurName<. Your stored packing station data
has been changed to: >M_Street< >M_ZipCode< >M_City<

BNK3=Notification ‘New Parcel’

Notification by E-Mail

A new packing station parcel has arrived for you.
Hello >M_Address< >M_SurName<.
A new parcel is waiting for you at the packing station automatic parcel
delivery machine >AUT_Street< in >AUT_ZipCode< >AUT_City<
You have seven days to pick up the parcel. Please remember to bring
along your client card and your PIN.

Notification by SMS

Hello >M_Address< >M_SurName<. A new parcel is waiting for you
at the packing station automatic parcel delivery machine >AUT_Street<
in >AUT_ZipCode< >AUT_City<

BNK3N=Notification ‘New Parcel with COD’

Notification by E-Mail

A new packing station COD parcel has arrived for you.
Hello >M_Address< >M_SurName<.
A new COD parcel is waiting for you at the packing station automatic
parcel delivery machine >AUT_Street< in
>AUT_ZipCode< >AUT_City<.
You have seven days to pick up the parcel. Please remember to bring
along your client card and your PIN. The COD amount is
>POD_amount<. You can pay with your EC card or money card.

Notification by SMS

Hello >M_Address< >M_SurName<. A new COD parcel
(>POD_amount<) is waiting for you at the packing station
automatic parcel delivery machine
>AUT_Street< in >AUT_ZipCode< >AUT_City<.

BNK4=Notification ‘Parcel has Been Waiting for 48 Hours’

Notification by E-Mail

A packing station parcel has been waiting for you for 48 hours.
Hello >M_Address< >M_SurName<.
Perhaps you have forgotten: a parcel is waiting for you at the packing
station automatic parcel delivery machine >AUT_Street< in
>AUT_ZipCode< >AUT_City<.
You still have five days to pick up the parcel. Please remember to
bring along your client card and your PIN.

Notification by SMS

Hello >M_Address< >M_SurName<. A parcel has been waiting for
you for 48 hours at the packing station automatic parcel delivery machine
>AUT_Street< in >AUT_ZipCode< >AUT_City<.

BNK4N=notification ‘Parcel with POD has Been Waiting for 48 Hours’

Notification by E-Mail

A packing station COD parcel has been waiting for you for 48 hours.
Hello >M_Address< >M_SurName<.
Perhaps you have forgotten: a COD parcel is waiting for you at the
packing station automatic parcel delivery machine >AUT_Street<
in >AUT_ZipCode< >AUT_City<.
You still have five days to pick up the parcel. Please remember to bring
along your client card and your PIN. The COD amount is
>POD_amount<. You can pay with your EC card or cash card.

Notification by SMS

Hello >M_Address< >M_SurName<. A COD parcel
(>POD_amount<) has been waiting for you for 48 hours at the packing
station automatic parcel delivery machine >AUT_Street< in
>AUT_ZipCode< >AUT_City<.

BNK5=Notification ‘Parcel Will be Removed in 48 Hours’

A packing station parcel is waiting for you.
Hello >M_Address< >M_SurName<.
Time is running out: a parcel is waiting for you at the packing station
automatic parcel delivery machine >AUT_Street< in >AUT_ZipCode<
>AUT_City<. This package will be sent back in 48 hours
as undeliverable if you do not pick it up. Please remember to bring
along your client card and your PIN.

Notification by SMS

Hello >M_Address< >M_SurName<. Your parcel at the packing
station automatic parcel delivery machine >AUT_Street< in >AUT_{—}
ZipCode< >AUT_City< will be sent back in 48 hours.

BNK5=Notification ‘COD Parcel Will be Removed in 48 Hours’

Notification by E-Mail

A packing station COD parcel is waiting for you.
Hello >M_Address< >M_SurName<.
Time is running out: a COD parcel is waiting for you at the packing
station automatic parcel delivery machine >AUT_Street<
in >AUT_ZipCode< >AUT_City<. This package
will be sent back in 48 hours as undeliverable if you do not pick it up.
Please remember to bring along your client card and your PIN. The COD
amount is >POD_amount<. You can pay with your EC card or cash card.

Notification by SMS

Hello >M_Address< >M_SurName<. Your COD parcel
(>POD_amount<) at the packing station automatic parcel delivery
machine >AUT_Street< in >AUT_ZipCode< >AUT_City< will be sent
back in 48 hours.

Requirements of Other Components
Object Parcel

An object Parcel has to be provided that supplies information about a parcel that is identified by an unambiguous parcel number:
The parcel has to provide a method that provides feedback on the expiry date on which the parcel will be removed from the automatic parcel delivery machine. This is needed in order to transmit notifications X days before the expiry. If no expiry date has been set, then as a standard procedure, a certain number of calendar days (e.g. 9 days) can be assumed.
The DeliveryContract object has to be delivered via a method.
The Parcel object provides a method with which to access the automatic parcel delivery machine in which the parcel is located.
   Object Machine

The object Machine allows access to the automatic parcel delivery machine database 90, which is identified by the automatic parcel delivery machine ID.
Methods in this object have to supply information about the location of an automatic parcel delivery machine.
   Objects to be Notified (Notifiable Objects): User, LogisticProvider and LogisticContractor

The object User supplies information about a client who is identified by the client number. The object LogisticProvider allows access to the logistic provider database. The object LogisticContractor supplies information about a logistic contractor.
All of the objects implement a shared interface Notifiable. It provides the requisite methods for sending a notification to the appertaining object, for example, for reading the e-mail address or the form of address.
It has to be possible to identify a Notifiable object by means of an unambiguous ID. For this purpose, for example, the ID of the User, the LogisticProvider object and the LogisticContractor object, concatenated with an identification of the object type (US_, LP_, LC_), can be given back via a method getUniqueID. This method should advantageously be defined in the interface Notifiable.
In order to reconstruct a Notifiable object again via this ID, an object factory is implemented which creates the appropriate object on the basis of such an ID.
   Logic Objects DeliveryContract, LogisticProvider and LogisticContractor
The B2B logic has to be queried for all objects, for example, via a shared interface.
Such an object has to be identified via an unambiguous ID. For this purpose, the ID of the Notifiable object (getUniqueID) can be used which already exists for the LogisticProvider and LogisticContractor. A corresponding method should also be present in the DeliveryContract which then provides feedback on the ID of the object, concatenated with an identification of the object type (DC_.

In order to further improve the procedure, it can be advantageous to carry out the following measures individually or together:
All of the e-mails are sent off-line in that they are written into a communication queue from which they are read out at regular intervals and processed.
The implementation can support any (but preferably fixed) languages.
E-mails are preferably sent as plain text.

Especially preferred embodiments of the invention, however, are:
Support of HTML formatted e-mail.
Here, at the time of registration, the client can choose the format in which he would like to receive e-mails (PlainText or HTML). Accordingly, different templates are used during the sending procedure.
Multi-language capability
The client can pick his preferred language at the time of registration. Accordingly, different templates are used during the sending procedure.
Support of notifications via the RFC1149 standard
Moreover, a Content Management System can be used to make it easier to manage the templates for e-mail and SMS.
   List of Reference Numerals
10 external interface
20 delivery contract logic
30 central sending component
40 communication request queue
41 timer
50 queue reader
70 client database
80 parcel database
90 automatic parcel delivery machine
100 document database
110 templates
120 gateway

1.-17. (canceled)

18. A method of transmitting notifications to users of a logistic system,
said logistic system comprising at least one parcel compartment system with at least one registered user, wherein notification orders are transmitted to a central sending component which, on the basis of the notification orders, accesses at least one database and generates and sends appropriate notifications to the user, the method comprising the steps of:
(a) calling up different modules with associated functions in response to different events within the logistic system, said modules being selected from the group consisting of a client database, a registration unit, and a system administration unit for the logistic system;
(b) generating notification orders by the modules;
(c)(i) transferring the notification orders to the central sending component so the orders can be sent immediately; or,
(ii) writing the notification orders into a communication request queue so the orders can be sent in a deferred manner; and
reading the orders from the communication request queue by a queue reader in a timer-controlled manner and transferring the orders to the central sending component;
(d) generating appropriate user-specific notifications by the central sending component; and,
(e) sending said notifications to the user by the central sending unit via a gateway;
wherein said generating step includes accessing at least one client database, a parcel database, an automatic parcel delivery machine database, and a document database by the central sending component, wherein said method further includes the step of validating the status of the notification orders in a delivery contract logic before transferring the notification orders to the central sending component.

19. The method of claim 18, comprising the step of allocating client data, parcel data, and parcel compartment system data in the databases by means of IDs.

20. The method claim 18, wherein the events in the logistic system comprise at least the following:
registration of the new user
change in the user data
placement of a new parcel in a parcel compartment system
picking up a parcel from a parcel compartment system
sending back a parcel
adding a substitute for pick-up of a parcel
removing a substitute.

21. The method of claim 18, comprising the step of sending the notifications to the users in the form of at least one of e-mail and SMS.

22. A device for transmitting notifications to users of a logistic system that operates one or more parcel compartment systems, wherein the logistic system comprises modules having functions for generating notification orders, of a central sending component, of a communication request queue, of a document database with templates for generating individual notifications for the specific users, of a client database with information about clients, of a parcel database with information about parcels, of an automatic parcel delivery machine database with information about parcel compartment systems and of a gateway for sending the notifications, wherein the modules are one or more of a client database, a registration unit and a system administration unit for the logistic system.
